(19) United States
(12) Patent Application Publication
(10) Pub. No.: US 2023/0011427 A1
(43) Pub. Date: Jan. 12, 2023

(54) VEHICLE GUIDANCE, POWER, COMMUNICATION SYSTEM AND METHOD

(71) Applicant: ZIRCON CHAMBERS PTY. LTD., Yeppoon, Queensland (AU)

(72) Inventor: Christopher Malcolm CHAMBERS, Yeppoon, Queensland (AU)

(21) Appl. No.: 17/782,764

(22) PCT Filed: Nov. 27, 2020
(86) PCT No.: PCT/AU2020/051291

§ 371 Date: Jun. 6, 2022

(30) Foreign Application Priority Data
Dec. 5, 2019 (AU) 2019904616
May 20, 2020 (AU) 2020901626

(51) Int. Cl. G08G 1/0967; B60W 60/00; B60R 16/033; E01F 9/30; E01F 9/524; H02J 7/00

(52) U.S. Cl. CPC G08G 1/096725; G08G 1/096766; B60W 60/001; B60R 16/033; E01F 9/30; E01F 9/524; H02J 7/00034; H02J 7/0071; B60W 2556/45; H02J 2310/48

(57) ABSTRACT

A vehicle communication, power, and guidance system for use in guiding and communicating with a land vehicle along a roadway, the system comprising: one or more reference devices positioned along the roadway, each of the reference devices further comprising: a memory device for storing fixed values for one or more vehicle and traffic related parameters; and one or more transmission modules for transmitting said fixed values for one or more vehicle and traffic related parameters; a vehicle mounted device comprising: a receiving module for receiving transmitted signals from the transmission module of said reference devices; and a processing module for processing the received signals and a transmitter module to transmitting signals to the reference device to communicate with one or more controllers of the vehicle to guide and control movement of the vehicle along the roadway.

### TECHNICAL FIELD

The present invention relates to a vehicle power, communication and guidance system for use in guiding, powering, and communicating with land vehicles along a roadway.

### BACKGROUND

Any references to methods, apparatus or documents of the prior art are not to be taken as constituting any evidence or admission that they formed, or form part of the common general knowledge.

The various roles of ground vehicles such as cars, buses and logistics vehicles are of critical importance in almost all industrialised economies. Enormous amounts of money have been spent in building ground transportation infrastructure. In more recent times, there has been tremendous progress in autonomous and semi-autonomous driving and driver aids which involve improvements in vehicle steering systems and navigation systems, typically by processing images obtained by vehicle mounted cameras and responding to the live capture of images by providing assistance in guiding and navigating the vehicle.

The driver of a conventional vehicle generally controls the course and speed of the vehicle by steering, accelerating and braking the vehicle. For example, cruise control systems are available that allow a driver to set a desired speed for the vehicle to travel. Normally, if the driver touches the brake pedal, the cruise control system is overridden and control of the vehicle speed is returned to the driver. If a driver depresses the accelerator pedal, the vehicle may remain in cruise control while the vehicle speed is increased while the accelerator remains depressed.

Autonomous control of vehicles for normal driving on roads is not yet fully available in vehicles. A fully autonomous vehicle control system would require sufficient information in order to undertake control of vehicle steering, acceleration and braking. Several factors make such systems unacceptable including the difficulty of anticipating upcoming roadway curvature, lane availability, merging lane locations, and the speed and location of surrounding vehicles. In addition, limitations on the ability to sense and quickly process data relating to lane location and the location of surrounding vehicles preclude truly fully autonomous control of vehicles on normal roadways. Roadways are dynamic systems that are constantly changing and it is difficult to program a vehicle for fully autonomous control.

In view of the above, it is desirable to provide an improved vehicle communication and guidance system that addresses some of the deficiencies of the prior art.

### SUMMARY OF INVENTION

In an aspect, the invention provides a vehicle communication and guidance system for use in guiding and communicating with a land vehicle along a roadway, the system comprising:

one or more reference devices positioned along a central portion of a lane of the roadway, each of the reference devices further comprising:

a memory device for storing one or more values for one or more vehicle and traffic related parameters; and

one or more transmission modules for transmitting said fixed values for one or more vehicle and traffic related parameters;

one or more receiving modules for receiving transmitted signals from the vehicle and communication centre;

a vehicle mounted device comprising:

a receiving module for receiving transmitted signals from the transmission module of said reference devices; and

a transmission module for transmitting said vehicle information to the vehicle reference device;

a processing module for processing the received signals and communicating with one or more controllers of the vehicle to guide and control movement of the vehicle along the lane of the roadway.

In an embodiment, a plurality of said reference devices are positioned in a spaced apart configuration along the roadway to allow continuous transmission of signals to the vehicle as the vehicle travels along the lane of the roadway.

In an embodiment, the reference devices are positioned along a central portion of each lane of the roadway.

In an embodiment, each of said one or more reference devices comprises a communication unit to communicate with another reference device, and/or also to and from a remotely located server to receive said values for one or more vehicle and traffic related parameters from the remotely located server.

In an embodiment, each of said reference devices comprises a fixing arrangement for fixing the reference devices on a surface of the roadway.

In an embodiment, each reference device further comprises a power supply for powering the memory devices and the transmission module.

In an embodiment, the memory device and the transmission module are housed with a housing body with at least one surface of the housing body being adapted to be positioned above the surface of the roadway to allow the transmitting module to transmit said signals to the vehicle mounted device.

In an embodiment, the reference device may further comprise at least one element that is visible during day and night to the vehicle mounted device. The at least one element may comprise a reflective material. The reflective material may have increased visibility upon exposure to light from street lamps or the vehicle's lights.

In an embodiment, each of said reference devices further comprises a power generation unit coupled to an input terminal of the reference device and at least one energy storage element coupled to said input terminal for powering the memory device and the transmission device. In a preferred form, the power generation unit comprises a photovoltaic unit.

In an embodiment, the system further comprises:

a first plurality of the vehicle mounted devices mounted along a substantially frontal portion of the vehicle for receiving a first plurality of vehicle and traffic related signals; and

a second plurality of the vehicle mounted devices mounted along a substantially rear portion of the vehicle for transmitting information to one or more of said reference devices located behind the vehicle.

In an embodiment, the information transmitted by the second plurality of vehicle mounted devices comprises feedback, said feedback being processed by a processor of the reference device in accordance with one or more pre-determined rules to optionally vary the values for one or more vehicle and traffic related parameters.

In an embodiment, the system further comprises a remotely located user input interface for receiving input from remote users in relation to the vehicle path and traffic related parameters thereby allowing the remote users to change or update said vehicle and traffic related parameters being transmitted to the vehicle, preferably to a control panel of the vehicle.

In an embodiment, the system further comprises a power exchange facility (PXF). The power exchange facility may have replacement battery packs. The power exchange facility may dispense fuel. The fuel may be conventional fuel (such as diesel or gasoline) or may be hydrogen or the like. The power exchange facility may remove a discharged battery pack from a vehicle and replace it with a charged battery pack.

The power exchange facility may operate in an autonomous, or at least semi-autonomous, manner. The power exchange facility may communicate with the vehicle mounted devices of vehicles to ascertain vehicle power requirements. The power exchange facility may provide battery charging related information over a network to the vehicles. Communication received from the power exchange facility may be used for scheduling charging of batteries by providing appropriate power exchange time slots and route access for vehicles.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of a guidance and communication system 100 for vehicles such as vehicle 200.

FIG. 2 is a detailed schematic box diagram of the guidance and communication system 100 for the vehicle 200.

FIG. 3 is a schematic view of the vehicle reference device 210 which is a part of the guidance and communication system 100.

FIG. 4 is a schematic illustration of another embodiment of a guidance and communication system 400.

FIG. 5 is a detailed box diagram of the guidance and communication system 400.

FIG. 6 is a detailed box diagram of the vehicle reference device 310A which is a part of the guidance and communication system 400.

FIG. 7 is a detailed box diagram of the vehicle reference device 310B which is a part of the guidance and communication system 400; and

FIG. 8 is a further schematic illustration of a guidance and communication system 400.

### DETAILED DESCRIPTION OF PREFERRED EMBODIMENTS

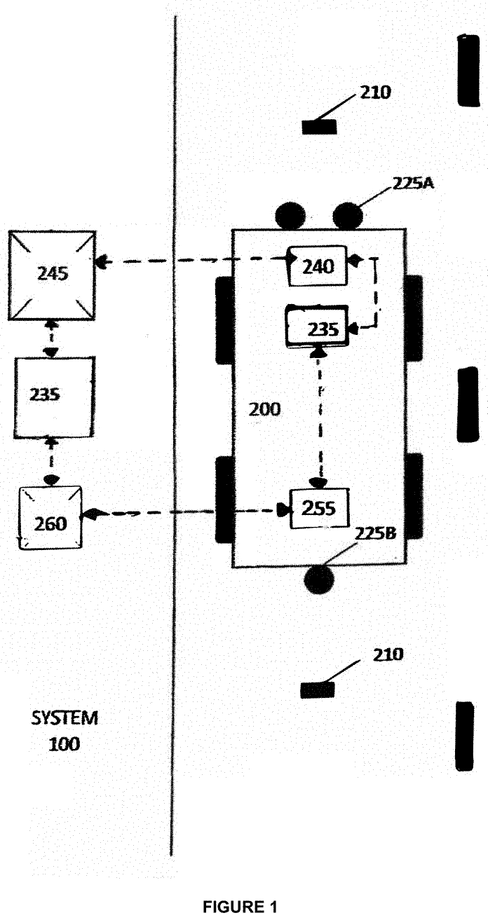

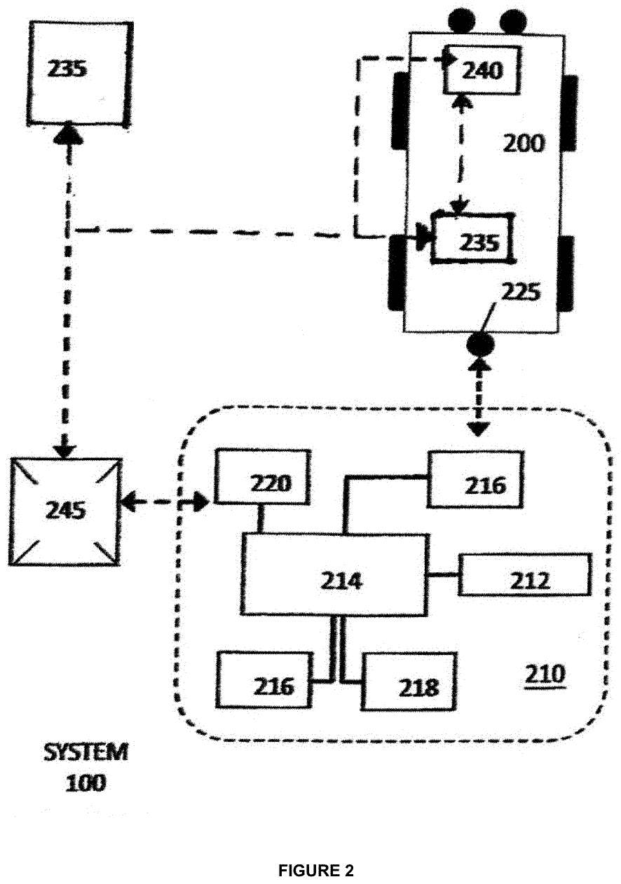

FIGS. 1 to 3 illustrate a vehicle communication and guidance system 100 in accordance with an embodiment of the present invention for use in guiding and communicating with a land vehicle 200 travelling along a roadway shown in FIGS. 1 and 2. The system 100 comprises a plurality of vehicle reference devices (VRD) 210 that are permanently anchored in every lane of the roadway. In the preferred embodiment, the VRD 210 are positioned at intervals (which may or may not be uniform) along the length of each lane in the roadway. In a preferred embodiment, the plurality of the vehicle reference devices 210 are anchored along a central portion of each lane shown in FIGS. 1 and 2. However, in other embodiments, the location of the vehicle reference devices 210 may be varied without departing from the spirit and scope of the invention. Each of the vehicle reference devices 210 may include a fixing arrangement for permanently fixing the vehicle reference devices 210 on or in a surface of the roadway.

The anchored vehicle reference devices 210 may include a transitory and/or non-transitory memory device 212 in communication with a processor 214. The memory device 212 may be a separate component or an integral component of the processor 214. A number of vehicle and traffic related parameters may be saved or changed to suit path conditions stored on the memory device 212. By way of example, the VRD devices 210 may include information in relation to recommended speed, lane access, permissible weight or freight load, and/or recommended directions. The VRD devices 210 may also provide the vehicle with information related to position and/or location of the land vehicle 200. A transmission module with one or more transmission devices 216 are operatively connected with the processor 214 to transmit signals including information from the vehicle and traffic related parameters stored on the memory device 212. Each reference device 210 may also include a power supply 218 for powering the memory device 212 and the transmission module. At least a portion of the transmission module 216, memory device 212 and other electronic componentry including the power supply 218 may be housed within a housing body with at least one surface of the housing body being adapted to be positioned above the surface of the roadway to allow the transmitting module to transmit said signals to the vehicle 200.

The vehicle 200 includes one or more vehicle mounted devices (VMD) 225 for receiving the signals transmitted by the transmission devices 216 on the VRD 210. The VMD 225 may be mounted along a frontal portion of a vehicle or along a rear portion of the vehicle. As shown in FIGS. 1 and 2, a plurality of vehicle mounted devices include a plurality of vehicle mounted devices 225A located along a frontal portion of the vehicle 200 and a single vehicle mounted device 225B located along a rear portion of the vehicle 200. It should be appreciated that a plurality of vehicle mounted devices 225B could also be provided at the rear of the vehicle 200.

Each of the VMD devices 225 includes a receiving module for receiving transmitted signals from the transmission module 216 of said vehicle reference devices 210; and a processing module for processing the received signals and communicating with one or more vehicle controllers 240 to guide and control movement of the vehicle 200 along the roadway. The vehicle mounted devices 225 may scan information received from the reference devices 210 and may further process signals received by the receiving module to control operation of the vehicle 200 in response to information provided by the VRD devices 210.

By way of example, the vehicle control surface may receive traffic hazard related information, by a receiver 220, from a remote communication centre 245 or via a mobile or remote user interface 235. In response the VMD 225 and/or vehicle controller 240 may process the hazard related information to result in controlling the movement of the vehicle 200 (controlling the speed, braking capability, lane guidance etc.) in an appropriate manner responsive to the hazard.

The reference devices 210 may include a communication unit 220 for communicating (exchanging information) over a network (including but not limited to a wireless network) with a remotely located communication centre 245, such as a server to communicate vehicle and traffic related parameters. By way of example, updated vehicle and traffic related parameters may be communicated from the remote communication centre 245 in a dynamic manner thereby allowing constantly updated and location specific information to be transmitted to the vehicle 200 via various means to also be logged and referenced to track vehicle movements from the remotely located communication centre 245. Such logs may be sent in the form of data packets or information communicated from the vehicle controllers 240 to the remote communication centre 245. The VRD 210 can be logged and referenced for future vehicle movement. This allows a vehicle 200 to operate within a desired road traffic parameter.

The vehicle mounted devices 225 in some embodiments, may incorporate a laser transmitter/receiver to calculate distance and trajectory relative to the reference devices 210 and also determine the vehicle position relative to its track over time. As shown in the accompanying figures, each vehicle 200 may be fitted with a plurality of mounting devices 225 thereby providing multiple transmitting and receiver points along the vehicle front and rear surfaces. The mounting devices 225 may in turn communicate with vehicle controllers 240 which may communicate with some of the vehicle's devices such as the navigation system, collision avoidance system, steering control etc. The position of the vehicle 200 may be calculated by using the plurality of the reference devices 210 anchored along each lane of the roadway.

A plurality of the reference devices 210 in a given area may be defined as a zone by a local governing body and an associated transportation authority to support semi or fully automated guided vehicles. The communication between the reference devices 210 and the remotely located communication centre 245 would enable the transportation authority to organise and operate a network of fully autonomous and semi-autonomous vehicles. The vehicle guidance and communication system 100 may be operated by providing a user interface in conjunction with the remote communication centre 245.

The vehicle guidance and communication system 100 may also be utilised for achieving a fully automated drive power exchange facility (PXF). The PXF may have replacement battery packs or dispense fuel such as a conventional fuel or, preferably, hydrogen biodiesels, or the like, for use in hydrogen engines or fuel cells. In the case of the PXF providing a battery exchange facility it may replace a discharged battery or battery pack with a fully charged battery or battery pack. In a preferred form, the battery or battery pack can be extracted from the vehicle, preferably by an under vehicle removal device at the PXF over which the vehicle 200 is driven to exchange. Batteries or battery packs removed from vehicles 200 may be charged at the PXF for reuse once sufficiently charged.

The PXF may communicate directly with the vehicle controller 240 and mobile/remote user interface 235 of a vehicle 200, in order to provide battery charging related information over the network to vehicles 200. The communication with the vehicle controller 240 may be used for scheduling charging of batteries by providing appropriate time slots and route access to improve battery charging management. Advantageously the PXF preferably provides a quick and automated power replacement solution for vehicles 200 that may be controlled, at least in part by the PXF, to provide optimum traffic flow whilst meeting the needs of the power requirements of the vehicles 200.

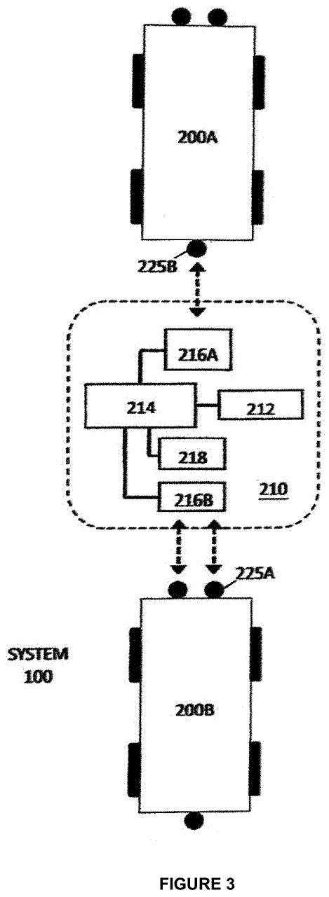

Referring to FIG. 3, each vehicle 200A, 200B may include a first plurality of the vehicle mounted devices 225A mounted along a substantially frontal portion of the vehicle 200A. 200B for receiving a first plurality of vehicle and traffic related signals; and a second plurality of the vehicle mounted devices 225B mounted along a substantially rear portion of the vehicle 200A, 200B for transmitting and receiving information to one or more of said reference devices 210 located behind the vehicle 200A, 200B. The information transmitted by the second plurality of vehicle mounted devices 225B may comprise feedback, said feedback being processed by the vehicle controller 240, in accordance with one or more pre-determined rules to optionally vary the values for one or more vehicle and traffic related parameters. By way of example, the first plurality of the vehicle mounted devices 225A may receive signals transmitted from the reference devices 210 to allow the control of the vehicle 200A, 200B whereas, the second plurality of the vehicle mounted devices 225B may provide the feedback signals thereby providing data on the vehicle's path or track along the roadway.

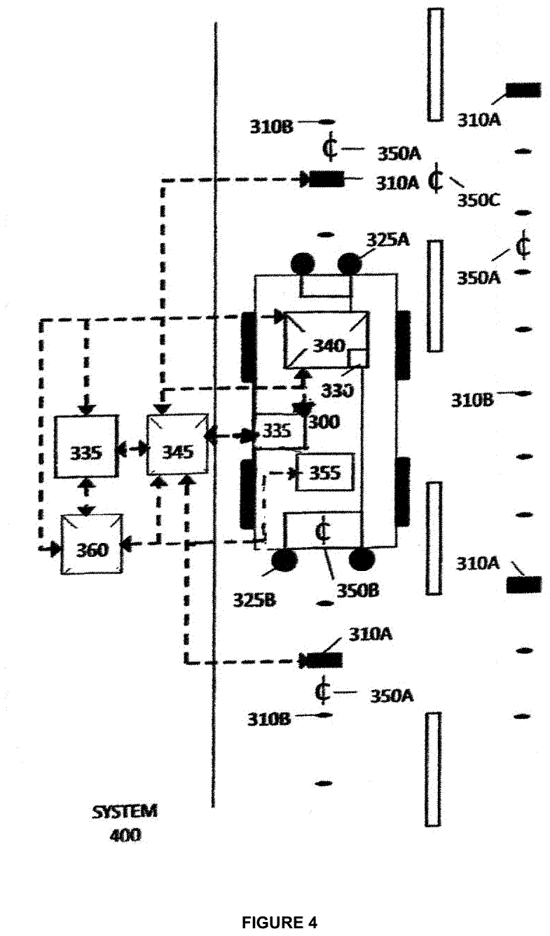

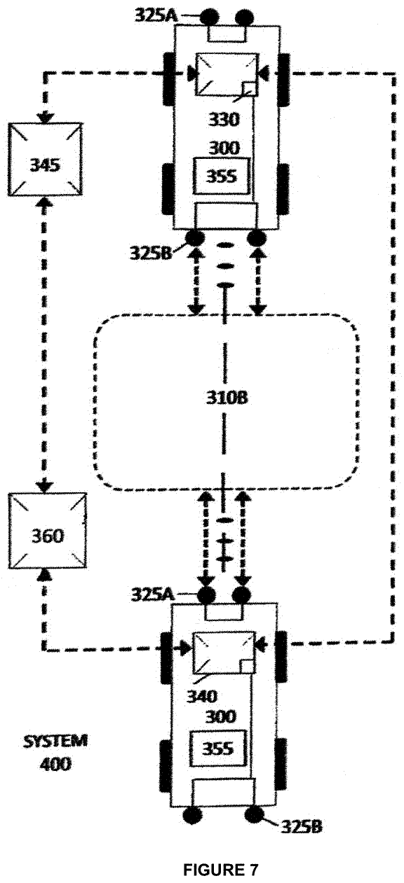

FIGS. 4 to 7 illustrate another vehicle communication and guidance system 400 in accordance with an embodiment of the present invention for use in guiding and communicating with a land vehicle 300 travelling along a roadway. The system 400 comprises a plurality of vehicle reference devices denoted by 310 including electrically operated reference devices 310A and passive positioning guidance devices 310B that are permanently anchored in every lane of the roadway. In a form the passive positioning guidance devices 310B may be reflective positioning devices comprising at least one reflective component.

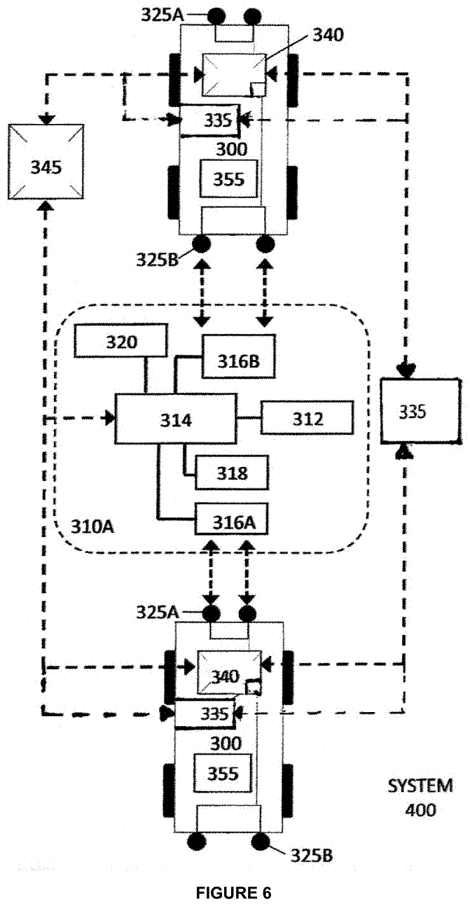

As seen in FIG. 6, the anchored reference devices 310A may include non-transitory memory 312 in communication with a processor 314. A number of vehicle and traffic related parameters may be saved on the memory 312. By way of example, the VRD devices 310A may include information in relation to recommended speed, lane access, permissible weight or freight load, and/or recommended directions. The VRD devices 310A may also provide the vehicle with information related to position and/or location of the land vehicle 300. A transmission module with one or more transmission devices 316A, 316B are operatively connected with the processor 314 to transmit signals including information to the vehicle 300 regarding traffic related parameters stored on the memory 312. Each reference device 310A may also include a power supply for powering the memory 312 and the transmission modules 316A, 316B.

Referring to FIG. 4, a central portion of each lane on a roadway is denoted by 350A along which a central part of the vehicle 300 should align. A central portion of the roadway is denoted by 350C along with visual markings in the form of dashed white lines separating lanes. At least a portion of the transmission modules 316A, 316B, memory 312 and other electronic componentry including the power supply may be housed with a housing body with at least one surface of the housing body being adapted to be positioned above the surface of the roadway to allow the transmitting modules 316A, 316B to transmit said signals to the vehicle 300.

The vehicle 300 includes one or more vehicle mounted devices (denoted generally by reference numeral 325) for receiving the signals transmitted by the transmission modules 316A, 316B of the VRD reference devices 310A. The vehicle mounted devices 325 may be mounted along a frontal portion of a vehicle or along a rear portion of the vehicle as shown in FIGS. 4 to 7.

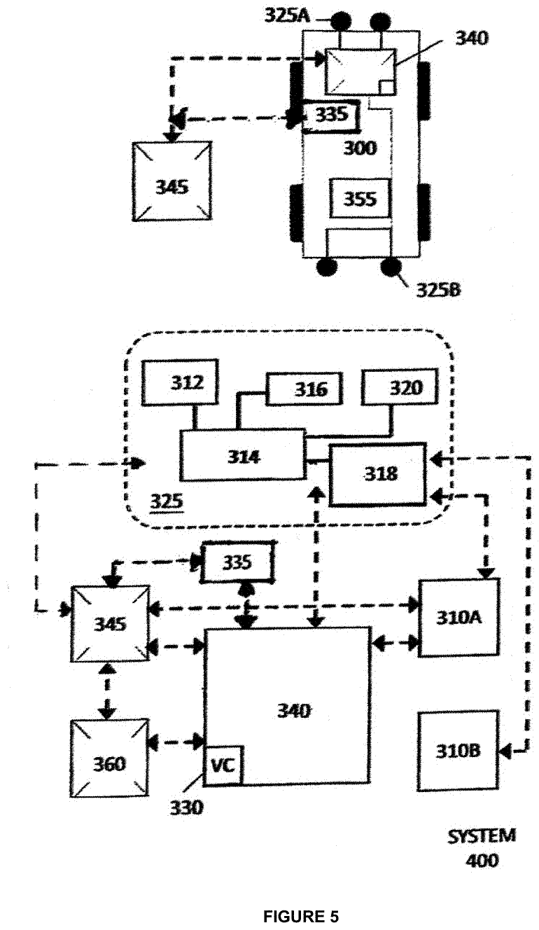

As seen in FIG. 5, each vehicle mounted device 325 includes a communication unit 318 with a transmitter module and a receiving module for receiving transmitted signals from the transmission module of said reference devices 310A and a processing module 314 for processing the received signals and communicating with one or more vehicle controlling devices 330 to guide and control movement of the vehicle 300 along the roadway. The mounted devices 325 may scan information received from the vehicle reference devices 310A or 310B and may further process the signals received by the receiving module to control operation of the vehicle 300 in response to information provided by the VRD devices 310. By way of example, the vehicle mounted devices 325 may receive traffic hazard related information from the reference devices 310A, the remote communication centre 345, and also via the remote user interface and in response may process the hazard related signals to result in controlling the movement of the vehicle 300 (controlling the speed, braking capability, route, lane guidance etc.) in response to the hazard related information provided by the reference devices 310A. Similarly, the vehicle mounted devices 325 may also receive information from the passive reflective reference devices 310B, process such information, and in response control the movement of the vehicle by way of the vehicle controlling devices 330.

The vehicle reference devices 310 may include a communication unit 318 for communicating (exchanging information) over a network (including but not limited to a wireless network) with a remotely located communication centre 345 such as a server to communicate vehicle and traffic related parameters by using a remote/mobile user interface 335. By way of example, updated vehicle and traffic related parameters may be communicated from the remote communication centre 345 in a dynamic manner thereby allowing constantly updated and location specific information to be transmitted to the vehicle 300 via e.g., vehicle reference devices 310. Each of the vehicle reference devices 310 may also be logged and referenced to track vehicle 300 movements from the remotely located communication centre 345. Such logs may be sent in the form of data packets or information communicated from the vehicle control panel 330 to the remote communication centre 345. The VRD 310 can be logged and referenced for future vehicle movement and this allows a vehicle to operate within a desired road traffic parameter.

As previously discussed, a plurality of the reference devices 310 in a given area may be defined as a zone by a local governing body and an associated transportation authority to support semi or fully automated guided vehicles. The communication between the reference devices 310 and the remotely located communication centre would enable the transportation authority to organise and operate a network of fully autonomous and semi-autonomous vehicles.

The vehicle guidance and communication system 400 may be operated by providing the remote/mobile user interface 335 in conjunction with the remote communication centre. The vehicle guidance and communication system 400 may also be utilised for achieving fully automated drive in style battery exchange facility that simply replaces a discharged battery 355 with a fully charged battery 355. The exchanging facility 360 then recharges the discharged battery to later fit another vehicle communicating directly to the network providing the vehicle control panel 340 in order to connect with battery charging related information over the network to vehicles 300. The communication with the vehicle control panel 330 and the remote/mobile user interface 335 for scheduling charging of batteries by providing appropriate time slots and route access to improve vehicle battery charging time frame and management.

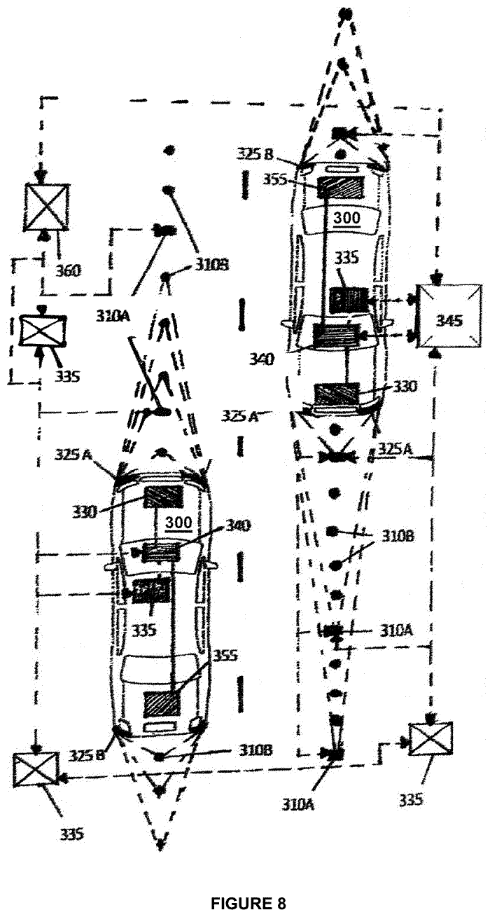

FIG. 8 illustrates a vehicle communication and guidance system in accordance with an embodiment of the present invention for use in guiding and communicating with land vehicles 300 travelling along a roadway. In this example the vehicles 300 are travelling in opposite directions, such as on a typical two lane roadway. As illustrated, the vehicle reference devices 310A, 310B can operate in a ‘piggyback’ type arrangement. Similarly, a plurality of remote/mobile user interfaces 335 can be ‘piggybacked’, being remote and/or mobile. The remote/mobile user interface 335 may comprise an application for a multipurpose electronic device, such as a smart phone, tablet, or laptop, or the like. The remote/mobile user interfaces 335 can be network connected by, for example, the Internet over existing wireless communication infrastructure such as over a 3 g/4 g/5 g mobile phone communications network.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A vehicle communication and guidance system for use in guiding and communicating with a vehicle along a roadway, the system comprising:
one or more reference devices positioned along a central portion of a lane of the roadway, the one or more reference devices further comprising:
a memory device for storing one or more values for one or more vehicle and traffic related parameters; and
one or more transmission modules for transmitting said values for one or more vehicle and traffic related parameters;
one or more receiver modules for receiving transmitted signals from a vehicle mounted device and a remotely located communication centre, wherein the vehicle mounted device comprises:
a receiving module for receiving transmitted signals from the transmission module of the one or more reference devices; and
a transmission device for transmitting signals from the vehicle mounted device to the vehicle one or more reference devices;
a processing module for processing the received signals and communicating with one or more controllers of the vehicle to guide and control movement of the vehicle along the roadway.

2. The vehicle communication and guidance system of claim 1, wherein a plurality of the one or more reference devices are positioned in a spaced apart configuration along the central portion of lane of the roadway to allow continuous transmission of signals to the vehicle as the vehicle travels along the lane of the roadway.

3. The vehicle communication and guidance system of claim 1, wherein the reference devices are positioned along a central portion of each lane of the roadway.

4. The vehicle communication and guidance system of claim 1, wherein each of said one or more reference devices comprises: a communication unit to communicate with a remotely located server to receive said values for one or more vehicle and traffic related parameters from the remotely located server.

5. The vehicle communication and guidance system of claim 1, wherein each of the one or more reference devices comprises: a fixing arrangement for fixing the reference devices on a surface of the roadway.

6. The vehicle communication and guidance system of claim 1, wherein each reference device further comprises a power supply for powering the memory devices and the transmission module.

7. The vehicle communication and guidance system of claim 1, wherein the memory device and the transmission module are housed with a housing body with at least one surface of the housing body being adapted to be positioned above the surface of the roadway to allow the transmitting module to transmit said signals to the vehicle mounted device.

8. The vehicle communication and guidance system of claim 7, wherein the reference device further comprises reflective material that is visible during day and night to the vehicle mounted device.

9. The vehicle communication and guidance system of claim 1, wherein each of the one or more reference devices further comprises: a power generation unit coupled to an input terminal of the reference device and at least one energy storage element coupled to said input terminal for powering the memory device and the transmission device.

10. The vehicle communication and guidance system of claim 1, comprising:
a first plurality of the vehicle mounted devices mounted along a substantially frontal portion of the vehicle for receiving a first plurality of vehicle and traffic related signals; and
a second plurality of the vehicle mounted devices mounted along a substantially rear portion of the vehicle for transmitting information to one or more of the one or more reference devices located behind the vehicle.

11. The vehicle communication and guidance system of claim 10, wherein the information transmitted by the second plurality of vehicle mounted devices comprises feedback, said feedback being processed by a processor of the reference device in accordance with one or more pre-determined rules to optionally vary the values for one or more vehicle and traffic related parameters.

12. The vehicle communication and guidance system of claim 4, further comprising a remotely located user input interface for receiving input from a remotely located server in relation to the vehicle and traffic related parameters thereby allowing the remote users to change or update said vehicle and traffic related parameters being transmitted to the vehicle.

13. The vehicle communication and guidance system of claim 1, comprising a power exchange facility configured to provide power to vehicles.

14. The vehicle communication and guidance system of claim 13, wherein the power exchange facility comprises replacement battery packs.

15. The vehicle communication and guidance system of claim 13, wherein the power exchange facility dispenses fuel.

16. The vehicle communication and guidance system of claim 13, wherein the power exchange facility is configured to remove a discharged battery pack from a vehicle and replace it with a charged battery pack.

17. The vehicle communication and guidance system of claim 13, wherein the power exchange facility provides battery charging related information over a network to vehicles.

18. The vehicle communication and guidance system of claim 17, wherein communication received from the power exchange facility is used for scheduling charging of batteries by providing appropriate power exchange time slots and route access for vehicles.
